(19) United States
(12) Patent Application Publication
(10) Pub. No.: US 2020/0078768 A1
(43) Pub. Date: Mar. 12, 2020

(54) DIESEL OXIDATION CATALYST

(71) Applicant: BASF CORPORATION, FLORHAM PARK, NJ (US)

(72) Inventor: JOSEPH A. PATCHETT, BASKING RIDGE, NJ (US)

(73) Assignee: BASF CORPORATION, FLORHAM PARK, NJ (US)

(21) Appl. No.: 16/682,118

(22) Filed: Nov. 13, 2019

Related U.S. Application Data
(63) Continuation of application No. PCT/IB2018/053361, filed on May 14, 2018.
(60) Provisional application No. 62/506,225, filed on May 15, 2017.

(51) Int. Cl. B01J 23/40; B01J 23/04; B01J 37/02; F01N 3/20; F01N 3/10

(52) U.S. Cl. CPC B01J 23/40; B01J 23/04; B01J 29/06; F01N 3/2066; F01N 3/106; B01J 37/0225

(57) ABSTRACT

The present disclosure relates to oxidation catalyst compositions which provide for oxidation of pollutants in an exhaust gas stream of an internal combustion engine. More specifically, the present disclosure relates to oxidation catalyst compositions which provide for oxidation of hydrocarbons (HC), carbon monoxide (CO) and nitrogen oxides (NOₓ) while minimizing N₂O formation. The oxidation catalyst compositions include a platinum group metal (PGM) component, a metal component selected from alkali and alkali earth metals, and support material on which the PGM component and metal component are supported.

### FIELD OF THE INVENTION

The present invention is directed to catalyst compositions suitable for treating exhaust gas streams of an internal combustion engine, for example, a diesel engine, as well as to catalytic articles and systems incorporating such compositions and methods of making and using the same.

### BACKGROUND OF THE INVENTION

Exhaust gas streams of internal combustion engines require treatment in order to address pollutants including carbon monoxide (CO), unburned hydrocarbons (HC), oxides of nitrogen (NOₓ) and particulate matter (PM). As world-wide emissions standards become ever more stringent, there is a continuing need to improve catalytic systems employed for these purposes.

Oxidation catalysts comprising a precious metal, such as platinum group metals (PGM), dispersed on a refractory metal oxide support, such as alumina, are used in treating the exhaust of internal combustion engines in order to convert both hydrocarbon and carbon monoxide gaseous pollutants by catalyzing the oxidation of these pollutants to carbon dioxide and water. Typically, the oxidation catalysts are formed on ceramic or metallic substrates upon which one or more catalyst coating compositions are deposited. In addition to the conversion of gaseous HC and CO emissions, oxidation catalysts that contain PGM promote the oxidation of NO to NO₂. Catalysts are typically defined by their light-off temperature or the temperature at which 50% conversion is attained, also called T₅₀.

For internal combustion engines, such as diesel engines, an oxidation catalyst article (known as a diesel oxidation catalyst (DOC)) is typically used to treat the exhaust gas streams. An undesired reaction that may occur with a DOC is undesired formation of nitrous oxide (N₂O), thought to occur via a reduction reaction of other nitrogen oxides. N₂O is almost 300 times more potent as a greenhouse gas than CO₂. Consequently, N₂O emissions are included in accessing the contribution of engines and vehicles to greenhouse gas emissions. In some cases, N₂O emissions are specifically limited by legislation. There is a need for DOCs with reduced N₂O formation (“N₂O make”).

### SUMMARY OF THE INVENTION

The present disclosure generally provides catalyst compositions, catalyst articles and catalyst systems comprising such catalyst articles which exhibit the ability to oxidize HC and CO and NOₓ with reduced formation of N₂O.

Accordingly, in a first aspect is provided an oxidation catalyst composition comprising a first platinum group metal (PGM) component, a metal component selected from the group consisting of alkali metals and alkali earth metals, and a support material, wherein the first PGM component and the metal component are supported on the support material.

In some embodiments, the support material comprises a molecular sieve. In some embodiments, the support material comprises a large pore molecular sieve. In some embodiments, the support material comprises a molecular sieve selected from the group consisting of framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET, and mixtures or intergrowths thereof. In some embodiments, the support material comprises a molecular sieve selected from the group consisting of framework types AFI, BEA, MAZ, MOR, and OFF.

In some embodiments, the support material comprises a molecular sieve having a silica-to-alumina ratio (SAR) of from about 1, about 2, about 5, about 8, about 10, about 15, about 20, or about 25, to about 30, about 35, about 40, about 45, about 50, about 60, about 70, about 80 about 90, about 100, about 150, about 200, about 260, about 300, about 400, about 500, about 750, or about 1000.

In some embodiments, the PGM component and the metal component are both supported on a molecular sieve. In some embodiments, the PGM component and the metal component are each supported on a different molecular sieve. In some embodiments, the PGM component and the metal component are both supported on the same molecular sieve.

In some embodiments, the support material comprises a refractory metal oxide. In some embodiments, the PGM component and the metal component are both supported on the refractory metal oxide. In some embodiments, the PGM component and the metal component are each supported on a different refractory metal oxide. In some embodiments, the PGM component and the metal component are both supported on the same refractory metal oxide.

In some embodiments, the support material comprises a refractory metal oxide and a molecular sieve. In some embodiments, the PGM component is supported on the molecular sieve, and the metal component is supported on the refractory metal oxide. In some embodiments, the PGM component is supported on the refractory metal oxide, and the metal component is supported on the molecular sieve. In some embodiments, the PGM component and the metal component are both supported on the molecular sieve. In some embodiments, the PGM component and the metal component are both supported on the refractory metal oxide.

In some embodiments, the support material comprises a refractory metal oxide comprising alumina, titania, zirconia, a mixture of alumina with one or more of titania, zirconia and ceria, ceria coated on alumina, titania coated on alumina, silica-alumina, aluminosilicates, alumina-zirconia, alumina-chromia, or alumina-ceria. In some embodiments, the support material comprises a refractory metal oxide selected from the group consisting of gamma alumina, silica-alumina, ceria coated on alumina, and titania coated on alumina. In some embodiments, the support material comprises ceria, alumina and zirconia or doped compositions thereof.

In some embodiments, the oxidation catalyst composition comprises alumina in an amount of from about 15 wt. %, about 20 wt. %, about 25 wt. %, about 30 wt. % or about 35 wt. %, to about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, or about 95 wt. %, based on the weight of the composition.

In some embodiments, the PGM component is present in an amount from about 0.1 wt. %, about 0.5 wt. %, about 1.0 wt. %, about 1.5 wt. %, or about 2.0 wt. % to about 3 wt. %, about 5 wt. %, about 7 wt. %, about 9 wt. %, about 10 wt. %, about 12 wt. %, about 15 wt. %, about 16 wt. %, about 17 wt. %, about 18 wt. %, about 19 wt. %, or about 20 wt. %, based on the weight of the composition.

In some embodiments, the alkali metal or alkali earth metal is present in an amount of from about 0.1 wt. %, about 0.3 wt. %, about 0.5 wt. %, or about 1.0 wt. %, to about 1.5 wt. %, about 2.0 wt. %, about 2.5 wt. %, about 3.0 wt. %, about 3.5 wt. %, or about 4.0 wt. %, based on the weight of the composition.

In some embodiments, the alkali metal comprises lithium, sodium, potassium, rubidium, cesium, or combinations thereof. In some embodiments, the alkali metal is sodium. In some embodiments, the alkali metal is lithium. In some embodiments, the alkali metal is potassium, In some embodiments, the alkali metal is rubidium. In some embodiments, the alkali metal is cesium. In some embodiments, the alkali metal is a combination of sodium and at least one of lithium, potassium, rubidium, or cesium.

In some embodiments, the alkali earth metal comprises magnesium, calcium, strontium, barium, or combinations thereof. In some embodiments, the alkali earth metal is magnesium. In some embodiments, the alkali earth metal is calcium. In some embodiments, the alkali earth metal is strontium. In some embodiments, the alkali earth metal is barium.

In some embodiments, the oxidation catalyst composition further comprises one or more catalytically active metals selected from the group consisting of copper, iron, manganese, cobalt, and nickel.

In another aspect is provided a catalytic article comprising a catalyst substrate having an inlet end and an outlet end defining an overall length, and a catalytic coating comprising one or more washcoats disposed thereon, wherein at least one of said washcoats comprises an oxidation catalyst composition comprising a PGM component and a metal component selected from the group consisting of alkali and alkali earth metals on a support.

In some embodiments, the catalytic coating further comprises a refractory metal oxide. In some embodiments, the catalytic coating comprises two or more washcoats. In some embodiments, the catalytic coating comprises a first washcoat comprising the oxidation catalyst composition disposed on at least a portion of the overall length of the catalyst substrate; and a second washcoat comprising a catalyst composition comprising a second PGM component supported on a second support material disposed on at least a portion of the overall length of the catalyst substrate, wherein the second washcoat contains essentially no alkali metals and alkali earth metals.

In some embodiments, the second washcoat is disposed directly on the catalyst substrate, and the first washcoat is on at least a portion of the second washcoat. In some embodiments, the first washcoat overlays the entire second washcoat. In some embodiments, the first washcoat is disposed directly on the catalyst substrate, and the second washcoat is on at least a portion of the first washcoat. In some embodiments, the second washcoat overlays the entire first washcoat. In some embodiments, the first washcoat is on the entire length of the catalyst substrate. In some embodiments, the second washcoat is on the entire length of the catalyst substrate. In some embodiments, the catalyst article has a zoned configuration, wherein the first washcoat is disposed on the catalyst substrate from the inlet end to a length from about 10% to about 70% of the overall length; and the second washcoat is disposed on the catalyst substrate from the outlet end to a length from about 30% to about 90% of the overall length. In some embodiments, the first washcoat and the second washcoat are adjacent and do not overlay each other. In some embodiments, the first washcoat and second washcoat are in direct contact. In some embodiments, at least a portion of the first and/or second washcoat is in direct contact with the substrate.

In some embodiments, the catalyst compositions are present in total from about 0.05 g/in³, about 0.1 g/in³, about 0.2 g/in³, about 0.3 g/in³, about 0.4 g/in³, about 0.5 g/in³, about 0.6 g/in³, about 0.7 g/in³, about 0.8 g/in³, about 0.9 g/in³, about 1.0 g/in³, about 1.2 g/in³, about 1.6 g/in³, about 2.0 g/in³, about 2.2 g/in³ or about 2.5 g/in³ to about 2.8 g/in³, about 3.0 g/in³, about 3.2 g/in³, about 3.5 g/in³, about 3.8 g/in³, about 4.0 g/in³, about 4.5 g/in³, about 5.0 g/in³, about 5.5 g/in³, about 6.0 g/in³, about 6.5 g/in³, about 7.0 g/in³, or about 8.0 g/in³, based on the volume of the substrate.

In some embodiments, the PGM components are present in total from about 2 g/ft³, about 5 g/ft³, about 10 g/ft³ to about 250 g/ft³, for example from about 20 g/ft³, about 30 g/ft³, about 40 g/ft³, about 50 g/ft³ or about 60 g/ft³ to about 100 g/ft³, about 150 g/ft³ or about 200 g/ft³, about 210 g/ft³, about 220 g/ft³, about 230 g/ft³, about 240 g/ft³ or about 250 g/ft³, based on the volume of the substrate.

In some embodiments, the catalytic article comprises alumina in an amount of from about 15 wt. %, about 20 wt. %, about 25 wt. %, about 30 wt. %, or about 35 wt. %, to about 50 wt. %, about 55 wt. %, about 60 wt. % about 65 wt. %, about 70 wt. %, about 75 wt. %, about 80 wt. %, or about 85 wt. %, based on the weight of the catalytic coating.

In some embodiments, the refractory metal oxide is present in a concentration of from about 0.5 g/in³, about 0.8 g/in³, or about 1.0 g/in³, to about 2.0 g/in³, about 3.0 g/in³, about 4.0 g/in³, about 5.0 g/in³, or about 6.0 g/in³, based on the substrate volume.

In some embodiments, the substrate is a flow-through monolith. In some embodiments, the substrate is a wall-flow filter.

In some embodiments, the first and/or second coating layer contains a further catalytically active metal selected from the group consisting of copper, iron, manganese, cobalt and nickel. In some embodiments, the further catalytically active metal is present in an amount from about 3 g/ft³, about 4 g/ft³, about 5 g/ft³, about 6 g/ft³, about 7 g/ft³, about 8 g/ft³, about 9 g/ft³ or about 10 g/ft³ to about 12 g/ft³, about 14 g/ft³, about 16 g/ft³, about 18 g/ft³, about 20 g/ft³, about 22 g/ft³, about 24 g/ft³, about 26 g/ft³, about 28 g/ft³, about 30 g/ft³, about 35 g/ft³ or about 40 g/ft³, based on the volume of the substrate.

In a further aspect is provided an exhaust gas treatment system comprising an internal combustion engine and the catalytic article as disclosed herein, wherein the catalytic article is downstream of and in fluid communication with the internal combustion engine.

In some embodiments, the exhaust gas treatment system further comprises one or more catalytic articles selected from the group consisting of an urea injector, a selective catalytic reduction (SCR) catalyst, a soot filter, an ammonia oxidation (AMO_{R}) catalyst, and a lean-NO_{R} trap (LNT).

In some embodiments, the exhaust gas treatment system comprises a first catalytic article comprising a first catalyst substrate having an overall length, the first catalyst substrate having a first washcoat comprising the oxidation catalyst composition as disclosed herein disposed on at least a portion of the overall length of the first catalyst substrate; and a second catalytic article comprising a second catalyst substrate having an overall length, the second catalyst substrate having a second washcoat disposed on at least a portion of the overall length of the catalyst substrate, the second washcoat comprising a catalyst composition comprising a second PGM component supported on a second support material, wherein the second washcoat contains essentially no alkali metals and alkali earth metals.

In some embodiments, the second catalytic article is downstream of and in fluid communication with the first catalytic article. In some embodiments, first catalytic article is downstream of and in fluid communication with the second catalytic article.

In another aspect is provided a catalytic article comprising a catalyst substrate having an inlet end and an outlet end defining an overall length; a first washcoat disposed on at least a portion of the overall length of the catalyst substrate, the first washcoat comprising an oxidation catalyst composition comprising a first platinum group metal (PGM) component, a metal component selected from the group consisting of alkali metals and alkali earth metals, and a support material, wherein the first PGM component and the metal component are supported on the support material; and a second washcoat comprising a catalyst composition comprising a second PGM component supported on a second support material disposed on at least a portion of the overall length of the catalyst substrate, wherein the second washcoat contains essentially no alkali or alkali earth metals.

In yet another aspect is provided a method for treating an exhaust gas stream comprising hydrocarbons and/or carbon monoxide and/or NO_{R}, the method comprising passing the exhaust stream through the catalytic article or system disclosed herein.

The present disclosure includes, without limitation, the following embodiments.

### Embodiment 1

An oxidation catalyst composition comprising a first platinum group metal (PGM) component, a metal component selected from the group consisting of alkali metals and alkali earth metals, and a support material, wherein the first PGM component and the metal component are supported on the support material.

### Embodiment 2

The oxidation catalyst composition of the preceding embodiment, wherein the support material comprises a molecular sieve.

### Embodiment 3

The oxidation catalyst composition of any preceding embodiment, wherein the support material comprises a large pore molecular sieve.

### Embodiment 4

The oxidation catalyst composition of any preceding embodiment, wherein the support material comprises a molecular sieve selected from the group consisting of framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET, and mixtures or intergrowths thereof.

### Embodiment 5

The oxidation catalyst composition of any preceding embodiment, wherein the support material comprises a molecular sieve selected from the group consisting of framework types AFI, BEA, MAZ, MOR, and OFF.

### Embodiment 6

The oxidation catalyst composition of any preceding embodiment, wherein the support material comprises a molecular sieve having a silica-to-alumina ratio (SAR) of from about 1, about 2, about 5, about 8, about 10, about 15, about 20, or about 25, to about 30, about 35, about 40, about 45, about 50, about 60, about 70, about 80 about 90, about 100, about 150, about 200, about 260, about 300, about 400, about 500, about 750, or about 1000.

### Embodiment 7

The oxidation catalyst composition of any preceding embodiment, wherein the PGM component and the metal component are both supported on the molecular sieve.

### Embodiment 8

The oxidation catalyst composition of any preceding embodiment, wherein the PGM component and the metal component are both supported on the same molecular sieve.

### Embodiment 9

The oxidation catalyst composition of any preceding embodiment, wherein the PGM component and the metal component are each supported on a different molecular sieve.

### Embodiment 10

The oxidation catalyst composition of any preceding embodiment, wherein the support material comprises a refractory metal oxide.

### Embodiment 11

The oxidation catalyst composition of any preceding embodiment, wherein the PGM component and the metal component are both supported on the refractory metal oxide.

### Embodiment 12

The oxidation catalyst composition of any preceding embodiment, wherein the PGM component and the metal component are both supported on the same refractory metal oxide.

### Embodiment 13

The oxidation catalyst composition of any preceding embodiment, wherein the PGM component and the metal component are each supported on a different refractory metal oxide.

### Embodiment 14

The oxidation catalyst composition of any preceding embodiment, wherein the PGM component is supported on the molecular sieve and the metal component is supported on the refractory metal oxide.

### Embodiment 15

The oxidation catalyst composition of any preceding embodiment, wherein the PGM component is supported on the refractory metal oxide and the metal component is supported on the molecular sieve.

### Embodiment 16

The oxidation catalyst composition of any preceding embodiment, wherein the support material comprises a refractory metal oxide comprising: alumina, titania, zirconia, a mixture of alumina with one or more of titania, zirconia and ceria, ceria coated on alumina, titania coated on alumina, silica-alumina, aluminosilicates, alumina-zirconia, alumina-chromia, or alumina-ceria.

### Embodiment 17

The oxidation catalyst composition of any preceding embodiment, wherein the support material comprises a refractory metal oxide selected from the group consisting of gamma alumina, silica-alumina, ceria coated on alumina, and titania coated on alumina.

### Embodiment 18

The oxidation catalyst composition of any preceding embodiment, wherein the support material comprises ceria, alumina and zirconia or doped compositions thereof.

### Embodiment 19

The oxidation catalyst composition of any preceding embodiment comprising alumina in an amount from about 15 wt. %, about 20 wt. %, about 25 wt. %, about 30 wt. % or about 35 wt. %, to about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, or about 95 wt. %, based on the weight of the composition.

### Embodiment 20

The oxidation catalyst composition of any preceding embodiment, wherein the PGM component is present in an amount from about 0.1 wt. %, about 0.5 wt. %, about 1.0 wt. %, about 1.5 wt. %, or about 2.0 wt. % to about 3 wt. %, about 5 wt. %, about 7 wt. %, about 9 wt. %, about 10 wt. %, about 12 wt. %, about 15 wt. %, about 16 wt. %, about 17 wt. %, about 18 wt. %, about 19 wt. %, or about 20 wt. %, based on the weight of the composition.

### Embodiment 21

The oxidation catalyst composition of any preceding embodiment, wherein the alkali metal or alkali earth metal is present in an amount of from about 0.1 wt. %, about 0.3 wt. %, about 0.5 wt. %, or about 1.0 wt. %, to about 1.5 wt. %, about 2.0 wt. %, about 2.5 wt. %, about 3.0 wt. %, about 3.5 wt. %, or about 4.0 wt. %, based on the weight of the composition.

### Embodiment 22

The oxidation catalyst composition of any preceding embodiment, wherein the alkali metal comprises lithium, sodium, potassium, or combinations thereof.

### Embodiment 23

The oxidation catalyst composition of any preceding embodiment, further comprising one or more catalytically active metals selected from the group consisting of copper, iron, manganese, cobalt, and nickel.

### Embodiment 24

A catalytic article comprising a catalyst substrate having an inlet end and an outlet end defining an overall length, and a catalytic coating comprising one or more washcoats disposed thereon, wherein at least one of said washcoats comprises the oxidation catalyst composition of any preceding embodiment.

### Embodiment 25

The catalytic article of the preceding embodiment, the catalytic coating further comprising a refractory metal oxide.

### Embodiment 26

The catalytic article of any preceding embodiment, wherein the catalytic coating comprises two or more washcoats.

### Embodiment 27

The catalytic article of any preceding embodiment, wherein the catalytic coating comprises a first washcoat comprising the oxidation catalyst composition disposed on at least a portion of the overall length of the catalyst substrate; and a second washcoat comprising a catalyst composition comprising a second PGM component supported on a second support material disposed on at least a portion of the overall length of the catalyst substrate, wherein the second washcoat contains essentially no alkali metals and alkali earth metals.

### Embodiment 28

The catalytic article of any preceding embodiment, wherein the second washcoat is disposed directly on the catalyst substrate, and the first washcoat is on at least a portion of the second washcoat.

### Embodiment 29

The catalytic article of any preceding embodiment, wherein the first washcoat overlays the entire second washcoat.

### Embodiment 30

The catalytic article of any preceding embodiment, wherein the first washcoat is disposed directly on the catalyst substrate, and the second washcoat is on at least a portion of the first washcoat.

### Embodiment 31

The catalytic article of any preceding embodiment, wherein the second washcoat overlays the entire first washcoat.

### Embodiment 32

The catalytic article of any preceding embodiment, wherein the first washcoat is on the entire length of the catalyst substrate.

### Embodiment 33

The catalytic article of any preceding embodiment wherein the second washcoat is on the entire length of the catalyst substrate.

### Embodiment 34

The catalytic article of any preceding embodiment, having a zoned configuration, wherein the first washcoat is disposed on the catalyst substrate from the inlet end to a length from about 10% to about 70% of the overall length; and the second washcoat is disposed on the catalyst substrate from the outlet end to a length from about 30% to about 90% of the overall length.

### Embodiment 35

The catalytic article of any preceding embodiment, wherein the first washcoat and the second washcoat are adjacent and do not overlay each other.

### Embodiment 36

The catalytic article of any preceding embodiment, wherein the first washcoat and second washcoat are in direct contact.

### Embodiment 37

A catalytic article of any preceding embodiment, wherein at least a portion of the first and/or second washcoats are in direct contact with the substrate.

### Embodiment 38

The catalytic article of any preceding embodiment, wherein the catalyst compositions are present in total from about 0.05 g/in³, about 0.1 g/in³, about 0.2 g/in³, about 0.3 g/in³, about 0.4 g/in³, about 0.5 g/in³, about 0.6 g/in³, about 0.7 g/in³, about 0.8 g/in³, about 0.9 g/in³, about 1.0 g/in³, about 1.2 g/in³, about 1.6 g/in³, about 2.0 g/in³, about 2.2 g/in³ or about 2.5 g/in³ to about 2.8 g/in³, about 3.0 g/in³, about 3.2 g/in³, about 3.5 g/in³, about 3.8 g/in³, about 4.0 g/in³, about 4.5 g/in³, about 5.0 g/in³, about 5.5 g/in³, about 6.0 g/in³, about 6.5 g/in³, about 7.0 g/in³, or about 8.0 g/in³, based on the volume of the substrate.

### Embodiment 39

The catalytic article of any preceding embodiment, wherein the PGM components are present in total from about 2 g/ft³, about 5 g/ft³, about 10 g/ft³ to about 250 g/ft³, for example from about 20 g/ft³, about 30 g/ft², about 40 g/ft², about 50 g/ft³ or about 60 g/ft³ to about 100 g/ft³, about 150 g/ft³ or about 200 g/ft², about 210 g/ft³, about 220 g/ft³, about 230 g/ft³, about 240 g/ft³ or about 250 g/ft², based on the volume of the substrate.

### Embodiment 40

The catalytic article of any preceding embodiment, comprising from about 15 wt. %, about 20 wt. %, about 25 wt. %, about 30 wt. %, or about 35 wt. %, to about 50 wt. %, about 55 wt. %, about 60 wt. % about 65 wt. %, about 70 wt. %, about 75 wt. %, about 80 wt. %, or about 85 wt. % alumina, based on the weight of the catalytic coating.

### Embodiment 41

The catalytic article of any preceding embodiment, wherein the refractory metal oxide is present in a concentration of from about 0.5 g/in², about 0.8 g/in², or about 1.0 g/in², to about 2.0 g/in², about 3.0 g/in², about 4.0 g/in², about 5.0 g/in², or about 6.0 g/in², based on the substrate volume.

### Embodiment 42

The catalytic article of any preceding embodiment, wherein the substrate is a flow-through monolith.

### Embodiment 43

The catalytic article of any preceding embodiment, wherein the substrate is a wall-flow filter.

### Embodiment 44

A catalytic article according to any preceding embodiment wherein the first and/or second coating layer further contains a catalytically active metal selected from the group consisting of copper, iron, manganese, cobalt and nickel from about 3 g/ft³, about 4 g/ft³, about 5 g/ft³, about 6 g/ft³, about 7 g/ft³, about 8 g/ft³, about 9 g/ft³ or about 10 g/ft³ to about 12 g/ft³, about 14 g/ft², about 16 g/ft², about 18 g/ft², about 20 g/ft², about 22 g/ft³, about 24 g/ft², about 26 g/ft³, about 28 g/ft², about 30 g/ft², about 35 g/ft³ or about 40 g/ft³, based on the volume of the substrate.

### Embodiment 45

An exhaust gas treatment system comprising an internal combustion engine and the catalytic article of any preceding embodiment, wherein the catalytic article is downstream of and in fluid communication with the internal combustion engine.

### Embodiment 46

The exhaust gas treatment system of any preceding embodiment, further comprising one or more catalytic articles selected from the group consisting of an urea injector, a selective catalytic reduction (SCR) catalyst, a soot filter, an ammonia oxidation (AMOₓ) catalyst, and a lean-NOₓ trap (LNT).

### Embodiment 47

An exhaust gas treatment system comprising a first catalytic article comprising a first catalyst substrate having an overall length, the first catalyst substrate having a first washcoat comprising the oxidation catalyst composition of any preceding embodiment disposed on at least a portion of the overall length of the first catalyst substrate; and a second catalytic article comprising a second catalyst substrate having an overall length, the second catalyst substrate having a second washcoat disposed on at least a portion of the overall length of the catalyst substrate, the second washcoat comprising a catalyst composition comprising a second PGM component supported on a second support material, wherein the second washcoat contains essentially no alkali metals and alkali earth metals.

### Embodiment 48

The treatment system of any preceding embodiment, wherein the second catalytic article is downstream of and in fluid communication with the first catalytic article.

### Embodiment 49

The treatment system of any preceding embodiment, wherein the first catalytic article is downstream of and in fluid communication with the second catalytic article.

### Embodiment 50

A method for treating an exhaust gas stream comprising hydrocarbons and/or carbon monoxide and/or NO_{R}, the method comprising passing the exhaust stream through the catalytic article or system of any preceding embodiment.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

In order to provide an understanding of embodiments of the invention, reference is made to the appended drawings, in which reference numerals refer to components of exemplary embodiments of the invention. The drawings are exemplary only, and should not be construed as limiting the invention. The disclosure described herein is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1a is a perspective view of a wall-flow filter substrate.

FIG. 1b is a cross-sectional view of a section of a wall-flow filter substrate.

FIG. 2a and FIG. 2b are illustrations of two possible coating configurations.

FIG. 3 is a graphical comparison of N₂O make of an inventive catalyst (Example 2) vs. a comparative catalyst (Example 1).

### DETAILED DESCRIPTION OF THE INVENTION

The present disclosure generally provides catalyst compositions, catalyst articles and catalyst systems comprising such catalyst articles which exhibit the ability to oxidize HC and CO and NO_{R} with reduced formation of N₂O.

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

### Definitions

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

The term “abatement” means a decrease in the amount, caused by any means.

The term “associated” means for instance “equipped with”, “connected to” or in “communication with”, for example “electrically connected” or in “fluid communication with” or otherwise connected in a way to perform a function. The term “associated” may mean directly associated with or indirectly associated with, for instance through one or more other articles or elements.

“Average particle size” is synonymous with D₅₀, meaning half of the population of particles has a particle size above this point, and half below. Particle size refers to primary particles. Particle size may be measured by laser light scattering techniques, with dispersions or dry powders, for example according to ASTM method D4464. D₉₀ particle size distribution indicates that 90% of the particles (by number) have a Feret diameter below a certain size as measured by Scanning Electron Microscopy (SEM) or Transmission Electron Microscopy (TEM) for submicron size particles; and a particle size analyzer for the support-containing particles (micron size).

The term “catalyst” refers to a material that promotes a chemical reaction. The catalyst includes the “catalytically active species” and the “carrier” that carries or supports the active species. For example, molecular sieves including zeolites may be carriers/supports for various metal active catalytic species. Likewise, refractory metal oxide particles may be carriers for various metal active catalytic species. The catalytically active species are also termed “promoters” as they promote chemical reactions. For instance, platinum group metal (PGM) containing molecular sieves may be termed PGM-promoted molecular sieves. A “promoted molecular sieve” refers to a molecular sieve to which catalytically active species are intentionally added. As such, the term “promoted” refers to a component that is intentionally added to the molecular sieve material, typically through ion exchange, as opposed to impurities inherent in the molecular sieve.

The term “functional article” means an article comprising a substrate having a functional coating composition disposed thereon, in particular a catalyst and/or sorbent coating composition.

The term “catalytic article” in the invention means an article comprising a substrate having a catalyst coating composition.

“CSF” refers to a catalyzed soot filter, which is a wall-flow monolith. A wall-flow filter consists of alternating inlet channels and outlet channels, where the inlet channels are plugged on the outlet end and the outlet channels are plugged on the inlet end. A soot-carrying exhaust gas stream entering the inlet channels is forced to pass through the filter walls before exiting from the outlet channels. In addition to soot filtration and regeneration, a CSF may carry oxidation catalysts to oxidize CO and HC to CO₂ and H₂O, or oxidize NO to NO₂ to accelerate downstream SCR catalysis or to facilitate the oxidation of soot particles at lower temperatures. A CSF, when positioned behind a LNT catalyst, can have a H₂S oxidation functionality to suppress H₂S emission during the LNT desulfation process. An SCR catalyst can also be, in some embodiments, coated directly onto a wall-flow filter, which is called a SCRoF.

“DOC” refers to a diesel oxidation catalyst, which converts hydrocarbons and carbon monoxide in the exhaust gas of a diesel engine. Typically, a DOC comprises one or more platinum group metals such as palladium and/or platinum; a support material such as alumina; zeolites for HC storage; and optionally promoters and/or stabilizers.

“LNT” refers to a lean NOₓ trap, which is a catalyst containing a platinum group metal, ceria, and an alkaline earth trap material suitable to adsorb NOₓ during lean conditions (for example, BaO or MgO). Under rich conditions, NOₓ is released and reduced to nitrogen.

As used herein, the phrase “catalyst system” refers to a combination of two or more catalysts, for example, a combination of a present oxidation catalyst and another catalyst, for example, a lean NOₓ trap (LNT), a catalyzed soot filter (CSF), or a selective catalytic reduction (SCR) catalyst. The catalyst system may alternatively be in the form of a washcoat in which the two or more catalysts are mixed together or coated in separate layers.

The term “configured” as used in the description and claims is intended to be an open-ended term as are the terms “comprising” or “containing”. The term “configured” is not meant to exclude other possible articles or elements. The term “configured” may be equivalent to “adapted”. In general, the term “effective” means for example from about 35% to 100% effective, for instance from about 40%, about 45%, about 50% or about 55% to about 60%, about 65%, about 70%, about 75%, about 80%, about 85%, about 90% or about 95%, regarding the defined catalytic activity or storage/release activity, by weight or by moles.

“Essentially free” means “little or no” or “no intentionally added,” and also having only trace and/or inadvertent amounts. For instance, in certain embodiments, “essentially free” means less than 2 wt. % (weight %), less than 1.5 wt. %, less than 1.0 wt. %, less than 0.5 wt. %, 0.25 wt. % or less than 0.01 wt. %, based on the weight of the indicated total composition.

The term “exhaust stream” or “exhaust gas stream” refers to any combination of flowing gas that may contain solid or liquid particulate matter. The stream comprises gaseous components and is for example exhaust of a lean burn engine, which may contain certain non-gaseous components such as liquid droplets, solid particulates and the like. The exhaust gas stream of a combustion engine typically further comprises combustion products (CO₂ and H₂O), products of incomplete combustion (carbon monoxide (CO) and hydrocarbons (HC)), oxides of nitrogen (NOₓ), combustible and/or carbonaceous particulate matter (soot), and un-reacted oxygen and nitrogen. As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine. The inlet end of a substrate is synonymous with the “upstream” end or “front” end. The outlet end is synonymous with the “downstream” end or “rear” end. An upstream zone is upstream of a downstream zone. An upstream zone may be closer to the engine or manifold, and a downstream zone may be further away from the engine or manifold.

The term “in fluid communication” is used to refer to articles positioned on the same exhaust line, i.e., a common exhaust stream passes through articles that are in fluid communication with each other. Articles in fluid communication may be adjacent to each other in the exhaust line. Alternatively, articles in fluid communication may be separated by one or more articles, also referred to as “washcoated monoliths.”

As used herein, the terms “nitrogen oxides” or “NOₓ” designate the oxides of nitrogen, such as NO or NO₂.

As used herein, “impregnated” or “impregnation” refers to permeation of the catalytic material into the porous structure of the support material.

As used herein, the term “support” or “support material” refers to any high surface area material, usually a metal oxide material, upon which a catalytic precious metal is applied. The term “on a support” means “dispersed on”, “incorporated into”, “impregnated into”, “on”, “in”, “deposited on” or otherwise associated with.

As used herein, the term “molecular sieves,” such as zeolites and other zeolitic framework materials (e.g. isomorphously substituted materials), refers to materials that may, in particulate form, support catalytic PGMs. Molecular sieves are materials based on an extensive three-dimensional network of oxygen ions containing generally tetrahedral type sites and having a substantially uniform pore distribution, with the average pore size being no larger than 20 Ångstroms (Å).

Molecular sieves can be zeolitic (zeolites) or may be non-zeolitic. Both zeolitic and non-zeolitic molecular sieves can have the chabazite crystal structure, which is also referred to as the CHA structure by the International Zeolite Association. Zeolitic chabazite includes a naturally occurring tectosilicate mineral of a zeolite group with approximate formula (Ca,Na₂,K₂,Mg)Al₂Si₄O_{12.6}H₂O (i.e., hydrated calcium aluminum silicate). Three synthetic forms of zeolitic chabazite are described in “Zeolite Molecular Sieves,” by D. W. Breck, published in 1973 by John Wiley & Sons, which is hereby incorporated by reference. The three synthetic forms reported by Breck are Zeolite K-G, described in J. Chem. Soc., p. 2822 (1956), Barrer et. Al.; Zeolite D, described in British Patent No. 868,846 (1961); and Zeolite R, described in U.S. Pat. No. 3,030,181. Synthesis of another synthetic form of zeolitic chabazite, SSZ-13, is described in U.S. Pat. No. 4,544,538. Synthesis of a synthetic form of a non-zeolitic molecular sieve having the chabazite crystal structure, silicoaluminophosphate 34 (SAPO-34), is described in U.S. Pat. No. 4,440,871 and U.S. Pat. No. 7,264,789. A method of making yet another synthetic non-zeolitic molecular sieve having chabazite structure, SAPO-44, is described for instance in U.S. Pat. No. 6,162,415.

Molecular sieves comprise small pore, medium pore and large pore molecular sieves or combinations thereof. The pore sizes are defined by the ring size. A small pore molecular sieve contains channels defined by up to eight tetrahedral atoms. A medium pore molecular sieve contains channels defined by ten-membered rings. A large pore molecular sieve contains channels defined by twelve-membered rings. As used herein, the term “small pore” refers to pore openings which are smaller than about 5 Å (Angstroms), for example on the order of about 3.8 Å.

Exemplary small pore molecular sieves include framework types ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures or intergrowths thereof.

The phrase “8-ring” molecular sieve refers to a molecular sieve having 8-ring pore openings and double-six ring secondary building units and having a cage like structure resulting from the connection of double six-ring building units by 4 rings. A synthetic 8-ring small pore molecular sieve (for example having the CHA structure) may be prepared via mixing a source of silica, a source of alumina and a structure directing agent under alkaline aqueous conditions. Typical silica sources include various types of fumed silica, precipitated silica and colloidal silica, as well as silicon alkoxides. Typical alumina sources include boehmites, pseudo-boehmites, aluminum hydroxides, aluminum salts such as aluminum sulfite or sodium aluminate and aluminum alkoxides. Sodium hydroxide is typically added to the reaction mixture. A typical structure directing agent for this synthesis is adamantyltrimethyl ammonium hydroxide, although other amines and/or quaternary ammonium salts may be substituted or added. The reaction mixture is heated in a pressure vessel with stirring to yield a crystalline product. Typical reaction temperatures are in the range of from about 100° C. to about 200° C., for instance from about 135° C. to about 170° C. Typical reaction times are between 1 hr and 30 days and in some embodiments, from 10 hours to 3 days. At the conclusion of the reaction, the pH is optionally adjusted to between 6 and 10, for example between 7 and 7.5 and the product is filtered and washed with water. Any acid can be used for pH adjustment, for instance nitric acid. Optionally, the product may be centrifuged. Organic additives may be used to help with the handling and isolation of the solid product. Spray-drying is an optional step in the processing of the product. The solid product is thermally treated in air or nitrogen. Alternatively, each gas treatment can be applied in various sequences or mixtures of gases can be applied. Typical calcination temperatures are in from about 400° C. to about 850° C. Molecular sieves having a CHA structure may be prepared for instance according to methods disclosed in U.S. Pat. Nos. 4,544,538 and 6,709,644.

Exemplary medium pore molecular sieves include framework types AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI, WEN and mixtures or intergrowths thereof.

Exemplary large pore molecular sieves include framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET and mixtures or intergrowths thereof.

As used herein, the term “zeolite” refers to a specific example of a molecular sieve, further including silicon and aluminum atoms. Generally, a zeolite is defined as an aluminosilicate with an open 3-dimensional framework structure composed of corner-sharing TO₄ tetrahedra, where T is Al or Si, or optionally P. Cations that balance the charge of the anionic framework are loosely associated with the framework oxygens, and the remaining pore volume is filled with water molecules. The non-framework cations are generally exchangeable, and the water molecules removable.

Aluminosilicate zeolite structures do not include phosphorus or other metals isomorphically substituted in the framework. That is, “aluminosilicate zeolite” excludes aluminophosphate materials such as SAPO, AlPO and MeAlPO materials, while the broader term “zeolite” includes aluminosilicates and aluminophosphates. For the purposes of this disclosure, SAPO, AlPO and MeAlPO materials are considered non-zeolitic molecular sieves.

Zeolites can be differentiated mainly according to the geometry of the voids which are formed by the rigid network of the (SiO₄)/AlO₄ tetrahedra. The entrances to the voids are formed from 6, 8, 10, or 12 ring atoms with respect to the atoms which form the entrance opening. Zeolites are crystalline materials having rather uniform pore sizes which, depending upon the type of zeolite and the type and amount of cations included in the zeolite lattice, range from about 3 to 10 Å in diameter.

A zeolite may comprise SiO₄/AlO₄ tetrahedra that are linked by common oxygen atoms to form a three-dimensional network. The molar ratio of silica-to-alumina (“SAR”) of a present zeolite can vary over a wide range, but is generally 2 or greater. For instance, a present zeolite may have a SAR of from about 5 to about 1000.

“Platinum group metal components” refer to platinum group metals or one of their oxides. “Rare earth metal components” refer to one or more oxides of the lanthanum series defined in the Periodic Table of Elements, including lanthanum, cerium, praseodymium and neodymium.

As used herein, the term “selective catalytic reduction” (SCR) refers to the catalytic process of reducing oxides of nitrogen to dinitrogen (N₂) using a nitrogenous reductant.

The term “sorbent” refers to a material that adsorbs and/or absorbs a desired substance, in this invention a NOₓ and/or CO and/or HC and/or NH₃. Sorbents may advantageously adsorb and/or absorb (store) a substance at a certain temperature and desorb (release) the substance at a higher temperature.

As used herein, the term “substrate” refers to the monolithic material onto which the catalyst composition, that is, catalytic coating, is disposed, typically in the form of a washcoat. In one or more embodiments, the substrates are flow-through monoliths and monolithic wall-flow filters. Flow-through and wall-flow substrates are also taught, for example, in International Application Publication No. WO2016/070090, which is incorporated herein by reference. A washcoat is formed by preparing a slurry containing a specified solids content (e.g., 30-90% by weight) of catalyst in a liquid, which is then coated onto a substrate and dried to provide a washcoat layer. Reference to “monolithic substrate” means a unitary structure that is homogeneous and continuous from inlet to outlet. A washcoat is formed by preparing a slurry containing a certain solid content (e.g., 20%-90% by weight) of particles in a liquid vehicle, which is then coated onto a substrate and dried to provide a washcoat layer.

The terms “on” and “over” in reference to a coating layer may be used synonymously. The term “directly on” means in direct contact with. The disclosed articles are referred to in certain embodiments as comprising one coating layer “on” a second coating layer, and such language is intended to encompass embodiments with intervening layers, where direct contact between the coating layers is not required (i.e., “on” is not equated with “directly on”).

As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated. The washcoat containing the metal-promoted molecular sieve of the invention can optionally comprise a binder selected from silica, alumina, titania, zirconia, ceria, or a combination thereof. The loading of the binder is about 0.1 to 10 wt. % based on the weight of the washcoat. As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can be different in some way (e.g., may differ in physical properties thereof such as, for example particle size or crystallite phase) and/or may differ in the chemical catalytic functions.

The term “vehicle” means, for instance, any vehicle having an internal combustion engine and includes, but is not limited to, passenger automobiles, sport utility vehicles, minivans, vans, trucks, buses, refuse vehicles, freight trucks, construction vehicles, heavy equipment, military vehicles, farm vehicles and the like.

Unless otherwise indicated, all parts and percentages are by weight. “Weight percent (wt. %),” if not otherwise indicated, is based on an entire composition free of any volatiles, that is, based on dry solids content.

All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

All U.S. patent applications, published patent applications and patents referred to herein are hereby incorporated by reference.

### Diesel Oxidation Catalyst (DOC) Compositions

Generally, a diesel oxidation catalyst (DOC) composition comprises one or more platinum group metal (PGM) components dispersed on a support, such as a refractory metal support. Various such DOC compositions are known for use in treating the exhaust of diesel engines in order to convert both hydrocarbon (HC) and carbon monoxide (CO) gaseous pollutants by catalyzing the oxidation of these pollutants to carbon dioxide and water.

The present DOC compositions (also referred to herein as “oxidation catalyst compositions”) comprise a catalytically active PGM component and a metal selected from the group consisting of alkali and alkali earth metals. PGM components useful in the disclosed DOC compositions include any component that includes a PGM, such as platinum, palladium, ruthenium, rhodium, osmium, iridium, and/or gold (Pt, Pd, Ru, Rh, Os, Ir, and/or Au). For example, the PGM may be in metallic form, with zero valence, or the PGM may be in an oxide form. The PGM components can include the PGM in any valence state. The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide. In some embodiments, the PGM component is a metal or an oxide thereof (e.g., including, but not limited to, platinum or an oxide thereof).

The PGM component of the disclosed oxidation catalyst compositions is typically present in an amount from about 0.1 wt. % (weight percent), about 0.5 wt. %, about 1.0 wt. %, about 1.5 wt. % or about 2.0 wt. % to about 3 wt. %, about 5 wt. %, about 7 wt. %, about 9 wt. %, about 10 wt. %, about 12 wt. %, about 15 wt. %, about 16 wt. %, about 17 wt. %, about 18 wt. %, about 19 wt. % or about 20 wt. %, based on the weight of the composition.

The metal component of the disclosed oxidation catalyst compositions comprises a metal component selected from the group consisting of alkali metals and alkali earth metals. In some embodiments, the alkali metal may be selected from one or more of lithium, sodium, potassium, rubidium or cesium. In some embodiments, the alkali earth metal may be selected from one or more of magnesium, calcium, strontium, or barium. In some embodiments, the alkali metal comprises lithium, sodium, potassium, rubidium, cesium, or combinations thereof. In some embodiments, the alkali metal is sodium. In some embodiments, the alkali metal is lithium. In some embodiments, the alkali metal is potassium, In some embodiments, the alkali metal is rubidium. In some embodiments, the alkali metal is cesium. In some embodiments, the alkali metal is a combination of sodium and at least one of lithium, potassium, rubidium, or cesium.

In some embodiments, the alkali earth metal comprises magnesium, calcium, strontium, barium, or combinations thereof. In some embodiments, the alkali earth metal is magnesium. In some embodiments, the alkali earth metal is calcium. In some embodiments, the alkali earth metal is strontium. In some embodiments, the alkali earth metal is barium.

The alkali metal or alkali earth metal of the disclosed oxidation catalyst composition is typically present in an amount of from about 0.1 wt. %, about 0.3 wt. %, about 0.5 wt. % or about 1.0 wt. % to about 1.5 wt. %, about 2.0 wt. %, about 2.5 wt. %, about 3.0 wt. %, about 3.5 wt. % or about 4.0 wt. %, based on the weight of the composition.

The disclosed oxidation catalyst compositions may optionally further comprise one or more additional catalytically active metals selected from the group consisting of copper, iron, chromium, manganese, cobalt, and nickel. In some embodiments, the additional catalytically active metal is manganese.

Typically the PGM component of the disclosed oxidation catalyst composition is supported on a support material. The PGM component can be, for example, supported on a refractory metal oxide and/or on a molecular sieve.

In some embodiments, the support material on which the catalytically active PGM component is deposited comprises a refractory metal oxide, which exhibits chemical and physical stability at high temperatures, such as the temperatures associated with gasoline or diesel engine exhaust. Exemplary refractory metal oxides include alumina, silica, zirconia, titania, ceria, praseodymia, tin oxide and the like, as well as physical mixtures or chemical combinations thereof, including atomically-doped combinations and including high surface area or activated compounds such as activated alumina.

High surface area refractory metal oxides that may be suitable for use to support the PGM component include alumina, titania, zirconia; mixtures of alumina with one or more of titania, zirconia and ceria; ceria coated on alumina or titania coated on alumina. The refractory metal oxide may contain an oxide or a mixed oxide such as silica-alumina, aluminosilicates which may be amorphous or crystalline, alumina-zirconia, alumina-chromia, alumina-ceria and the like. The refractory metal oxides are in particular gamma alumina, silica-alumina, ceria coated on alumina, titania coated on alumina or zirconia coated on alumina. Included are combinations of metal oxides such as silica-alumina, ceria-zirconia, praseodymia-ceria, alumina-zirconia, alumina-ceria-zirconia, lanthana-alumina, lanthana-zirconia-alumina, baria-alumina, baria-lanthana-alumina, baria-lanthana-neodymia alumina and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina and low bulk density large pore boehmite and gamma-alumina.

High surface area metal oxide supports, such as alumina support materials, also referred to as “gamma alumina” or “activated alumina,” typically exhibit a BET surface area in excess of 60 m²/g, often up to about 200 m²/g or higher. An exemplary refractory metal oxide comprises high surface area γ-alumina having a specific surface area of about 50 to about 300 m²/g. Such activated alumina is usually a mixture of the gamma and delta phases of alumina, but may also contain substantial amounts of eta, kappa and theta alumina phases. “BET surface area” has its usual meaning of referring to the Brunauer-Emmett-Teller method for determining surface area by N₂ adsorption measurements. Unless otherwise stated, “surface area” refers to BET surface area. Desirably, the active alumina has a specific surface area of about 60 to about 350 m²/g, for example from about 90 to about 250 m²/g.

In certain embodiments, metal oxide supports useful in the catalyst compositions disclosed herein are doped alumina materials, such as Si-doped alumina materials (including, but not limited to 1-10% SiO₂—Al₂O₃), doped titania materials, such as Si-doped titania materials (including, but not limited to 1-10% SiO₂—TiO₂), or doped zirconia materials, such as Si-doped ZrO₂ (including, but not limited to 5-30% SiO₂—ZrO₂).

Advantageously, a refractory metal oxide may be doped with one or more additional basic metal oxide materials such as lanthanum, barium, praseodymium, neodymium, samarium, strontium, calcium, magnesium, niobium, hafnium, gadolinium, terbium, dysprosium, erbium, ytterbium, tin, or zinc. In some embodiments, the metal oxide dopant may be selected from lanthanum oxide, barium oxide, strontium oxide, calcium oxide, magnesium oxide or combinations thereof. The metal oxide dopant, where present, is typically present in an amount of about 1 to about 20% by weight, based on the weight of the catalyst composition. The dopant oxide materials, without wishing to be bound by theory, may serve to improve the high temperature stability of the refractory metal oxide support or function as a sorbent for acidic gases such as NO₂, SO₂ or SO₃.

The dopant metal oxides can be introduced using an incipient wetness impregnation technique or through usage of colloidal mixed oxide particles. Preferred dopant metal oxides include colloidal baria-alumina, baria-zirconia, baria-titania, zirconia-alumina, baria-zirconia-alumina, lanthana-zirconia and the like. Thus, the refractory metal oxides or refractory mixed metal oxides in the disclosed catalyst composition are most typically selected from the group consisting of alumina, zirconia, silica, titania, ceria, for example bulk ceria, manganese oxide, zirconia-alumina, ceria-zirconia, ceria-alumina, lanthana-alumina, baria-alumina, silica, silica-alumina and combinations thereof. These refractory metal oxides may be further doped with base metal oxides such as baria-alumina, baria-zirconia, baria-titania, zirconia-alumina, baria-zirconia-alumina, lanthana-zirconia and the like. Advantageously, the oxidation catalyst composition may comprise ceria, alumina and zirconia or doped compositions thereof.

The oxidation catalyst composition may comprise any of the above-named refractory metal oxides and in any amount. For example, refractory metal oxides in the oxidation catalyst composition may comprise at from about 15 wt. %, about 20 wt. %, about 25 wt. %, about 30 wt. % or about 35 wt. % to about 50 wt. %, about 55 wt. %, about 60 wt. % about 65 wt. % or about 70 wt. % based on the total dry weight of the catalyst composition. The oxidation catalyst composition may, for example, comprise from about 10 to about 99 wt. % alumina, from about 15 to about 95 wt. % alumina or from about 20 to about 85 wt. % alumina.

The PGM component may be dispersed on the refractory metal oxide support by, for example, dispersing a soluble precursor (e.g., palladium nitrate) thereon. Alternatively, the PGM component is provided in particulate form in the composition, such as fine particles as small as 1 to 15 nanometers in diameter or smaller, as opposed to being dispersed on the support.

Supports for the PGM component also include molecular sieves. Useful molecular sieves have 8-ring pore openings and double-six ring secondary building units, for example, those having structure types AEI, AFT, AFX, CHA, EAB, ERI, KFI, LEV, SAS, SAT or SAV. Included are any and all isotopic framework materials such as SAPO, ALPO and MeAPO materials having the same structure type. The 8-ring small pore molecular sieves include aluminosilicates, borosilicates, gallosilicates, MeAPSOs and MeAPOs. These include for example SSZ-13, SSZ-62, natural chabazite, zeolite K-G, Linde D, Linde R, LZ-218, LZ-235, LZ-236, ZK-14, SAPO-34, SAPO-44, SAPO-47, ZYT-6, CuSAPO-34, CuSAPO-44 and CuSAPO-47. In some embodiments, the 8-ring small pore molecular sieve will have an aluminosilicate composition, such as SSZ-13 and SSZ-62.

In one or more embodiments, the 8-ring small pore molecular sieve has the CHA crystal structure and is selected from the group consisting of aluminosilicate zeolite having the CHA crystal structure, SAPO, ALPO and MeAPO. For example, the 8-ring small pore molecular sieve having the CHA crystal structure is an aluminosilicate zeolite having the CHA crystal structure. In one embodiment, the 8-ring small pore molecular sieve having the CHA crystal structure will have an aluminosilicate composition, such as SSZ-13 and SSZ-62.

In some embodiments, the molecular sieve is a small pore molecular sieve selected from the group consisting aluminosilicate molecular sieves, metal-containing aluminosilicate molecular sieves, aluminophosphate (ALPO) molecular sieves, metal-containing aluminophosphate (MeALPO) molecular sieves, silico-aluminophosphate (SAPO) molecular sieves, and metal-containing silico-aluminophosphate (MeSAPO) molecular sieves and mixtures thereof. For example, small pore molecular sieves can be selected from the group consisting of framework types ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures or intergrowths thereof. For instance, the small pore molecular sieve in some embodiments is selected from the group of framework types CHA, LEV, AEI, AFX, ERI, SFW, KFI, DDR and ITE.

In some embodiments, the molecular sieve is a medium pore molecular sieve selected from the group consisting of framework types AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, PAR, PCR, PON, PUN, RRO, RSN, SFF, SFG, STF, STI, STT, STW, SVR, SZR, TER, TON, TUN, UOS, VSV, WEI, WEN and mixtures or intergrowths thereof. For instance, the medium pore molecular sieves in some embodiments are selected from the group consisting of framework types FER, MEL, MFI and STT.

In some embodiments, the molecular sieve is a large pore molecular sieve selected from the group consisting of framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET and mixtures or intergrowths thereof. For instance, the large pore molecular sieves in some embodiments are selected from the group consisting of framework types AFI, BEA, MAZ, MOR and OFF. Advantageously, the molecular sieves of the present catalyst compositions are large pore molecular sieves.

In some embodiments, the molecular sieve comprises a framework type selected from the group consisting of AEI, BEA (Beta zeolites), CHA (chabazite), FAU (zeolite Y), FER (ferrierite), MFI (ZSM-5) and MOR (mordenite). Non-limiting examples of zeolites having these structures include chabazite, faujasite, zeolite Y, ultrastable zeolite Y, Beta zeolite, mordenite, silicalite, zeolite X, and ZSM-5.

Molecular sieves may, in some embodiments, exhibit a high surface area, for example a BET surface area, determined according to DIN 66131, of at least about 400 m²/g, at least about 550 m²/g or at least about 650 m²/g, for example from about 400 to about 750 m²/g or from about 500 to about 750 m²/g. The present molecular sieves may have a mean crystal size of from about 10 nanometers to about 10 microns, from about 50 nanometers to about 5 microns or from about 0.1 microns to about 0.5 microns as determined via SEM. For instance, the molecular sieve crystallites may have a crystal size greater than 0.1 microns or 1 micron and less than 5 microns.

Molecular sieves in some embodiments may have a silica to alumina ratio (SAR) of from about 1, about 2, about 5, about 8, about 10, about 15, about 20 or about 25 to about 30, about 35, about 40, about 45, about 50, about 60, about 70, about 80 about 90, about 100, about 150, about 200, about 260, about 300, about 400, about 500, about 750 or about 1000. For instance, the molecular sieves may have a SAR of from about 5 to about 250, from about 10 to about 200, from about 2 to about 300, from about 5 to about 250, from about 10 to about 200, from about 10 to about 100, from about 10 to about 75, from about 10 to about 60, from about 10 to about 50, from about 15 to about 100, from about 15 to about 75, from about 15 to about 60, from about 15 to about 50, from about 20 to about 100, from about 20 to about 75, from about 20 to about 60 or from about 20 to about 50.

Molecular sieves may be provided in the form of a powder or a spray-dried material is admixed with or coated with suitable modifiers. Modifiers include silica, alumina, titania, zirconia, ceria and metal oxide binders (for example a zirconium precursor, or a ceria precursor). The powder or the spray-dried material, optionally after admixing or coating by suitable modifiers, may be formed into a slurry, for example with water, which is deposited on a suitable substrate as disclosed for example in U.S. Pat. No. 8,404,203, to form a catalytic coating layer.

In embodiments where the PGM component is supported on a molecular sieve, the molecular sieves are PGM component containing. In PGM component containing molecular sieves, the PGM component resides in the ion-exchange sites (pores) of the molecular sieves, and may also be associated with the molecular sieves but not “in” the pores.

The amount of PGM in a molecular sieve, for example an aluminosilicate zeolite, may also be defined by the PGM-to-aluminum (PGM/Al) atomic ratio. For example the PGM/Al atomic ratio for the present molecular sieves may be from about 0.05, about 0.10, about 0.15, about 0.20, about 0.25, about 0.30, about 0.35, about 0.40 or about 0.45 to about 0.15, about 0.20, about 0.25, about 0.30, about 0.35, about 0.40, about 0.45, about 0.50 or about 0.55.

Typically, the alkali metal or alkali earth metal component of the disclosed oxidation catalyst composition is supported on a support material. The alkali metal or alkali earth metal component can be, for example, supported on a refractory metal oxide and/or on a molecular sieve. In embodiments where the alkali metal or alkali earth metal component is supported on a molecular sieve, the molecular sieves are alkali metal or alkali earth metal component containing. In alkali metal or alkali earth metal component containing molecular sieves, the alkali metal or alkali earth metal component resides in the ion-exchange sites (pores) of the molecular sieves, and may also be associated with the molecular sieves but not “in” the pores.

The PGM-containing and alkali metal or alkali earth metal-containing molecular sieves are prepared, for example, via incipient wetness techniques from a H⁺ form molecular sieve, and a metal salt (e.g., a PGM salt and/or an alkali metal salt or alkali earth metal salt). Further, at least a portion of a catalytically active metal (e.g., a PGM) may be included during a molecular sieve synthetic process such that a tailored colloid contains a structure directing agent, a silica source, an alumina source and a metal ion (e.g. PGM) source.

### Catalytic Articles

To produce catalytic articles of the present disclosure, a substrate as described herein is coated with an oxidation catalyst composition as disclosed herein.

### Substrates

In one or more embodiments, the present catalyst compositions are disposed on a substrate to form a catalytic article. Catalytic articles comprising the substrates are generally employed as part of an exhaust gas treatment system (e.g., catalyst articles including, but not limited to, articles including the DOC compositions disclosed herein). Useful substrates are 3-dimensional, having a length and a diameter and a volume, similar to a cylinder. The shape does not necessarily have to conform to a cylinder. The length is an axial length defined by an inlet end and an outlet end.

According to one or more embodiments, the substrate for the disclosed composition(s) may be constructed of any material typically used for preparing automotive catalysts and will typically comprise a metal or ceramic honeycomb structure. The substrate typically provides a plurality of wall surfaces upon which the washcoat composition is applied and adhered, thereby acting as a substrate for the catalyst composition.

Ceramic substrates may be made of any suitable refractory material, e.g. cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

Substrates may also be metallic, comprising one or more metals or metal alloys. A metallic substrate may include any metallic substrate, such as those with openings or “punch-outs” in the channel walls. The metallic substrates may be employed in various shapes such as pellets, corrugated sheet or monolithic foam. Specific examples of metallic substrates include heat-resistant, base-metal alloys, especially those in which iron is a substantial or major component. Such alloys may contain one or more of nickel, chromium, and aluminum, and the total of these metals may advantageously comprise at least about 15 wt. % (weight percent) of the alloy, for instance, about 10 to about 25 wt. % chromium, about 1 to about 8 wt. % of aluminum, and from 0 to about 20 wt. % of nickel, in each case based on the weight of the substrate. Examples of metallic substrates include those having straight channels; those having protruding blades along the axial channels to disrupt gas flow and to open communication of gas flow between channels; and those having blades and also holes to enhance gas transport between channels allowing for radial gas transport throughout the monolith. Metallic substrates, in particular, may be advantageously employed in certain embodiments in a close-coupled position, allowing for fast heat-up of the substrate and, correspondingly, fast heat up of a catalyst composition coated therein (e.g., a DOC catalyst composition).

Any suitable substrate for the catalytic articles disclosed herein may be employed, such as a monolithic substrate of the type having fine, parallel gas flow passages extending there through from an inlet or an outlet face of the substrate such that passages are open to fluid flow there through (“flow-through substrate”). Another suitable substrate is of the type have a plurality of fine, substantially parallel gas flow passages extending along the longitudinal axis of the substrate where, typically, each passage is blocked at one end of the substrate body, with alternate passages blocked at opposite end-faces (“wall-flow filter”). Flow-through and wall-flow substrates are also taught, for example, in International Application Publication No. WO2016/070090, which is incorporated herein by reference in its entirety.

In some embodiments, the catalyst substrate comprises a honeycomb substrate in the form of a wall-flow filter or a flow-through substrate. In some embodiments, the substrate is a wall-flow filter. Flow-through substrates and wall-flow filters will be further discussed herein below.

### Flow-Through Substrates

In some embodiments, the substrate is a flow-through substrate (e.g., monolithic substrate, including a flow-through honeycomb monolithic substrate). Flow-through substrates have fine, parallel gas flow passages extending from an inlet end to an outlet end of the substrate such that passages are open to fluid flow. The passages, which are essentially straight paths from their fluid inlet to their fluid outlet, are defined by walls on which a catalytic coating is disposed so that gases flowing through the passages contact the catalytic material. The flow passages of the flow-through substrate are thin-walled channels, which can be of any suitable cross-sectional shape and size such as trapezoidal, rectangular, square, sinusoidal, hexagonal, oval, circular, etc. The flow-through substrate can be ceramic or metallic as described above.

Flow-through substrates can, for example, have a volume of from about 50 in³ to about 1200 in³, a cell density (inlet openings) of from about 60 cells per square inch (cpsi) to about 500 cpsi or up to about 900 cpsi, for example from about 200 to about 400 cpsi and a wall thickness of from about 50 to about 200 microns or about 400 microns.

A catalytic article can be provided by applying a catalytic coating (e.g., as disclosed here) to the substrate as a washcoat.

### Wall-Flow Filter Substrates

In some embodiments, the substrate is a wall-flow filter, which generally has a plurality of fine, substantially parallel gas flow passages extending along the longitudinal axis of the substrate. Typically, each passage is blocked at one end of the substrate body, with alternate passages blocked at opposite end-faces. Such monolithic wall-flow filter substrates may contain up to about 900 or more flow passages (or “cells”) per square inch of cross-section, although far fewer may be used. For example, the substrate may have from about 7 to 600, more usually from about 100 to 400, cells per square inch (“cpsi”). The cells can have cross-sections that are rectangular, square, circular, oval, triangular, hexagonal, or are of other polygonal shapes.

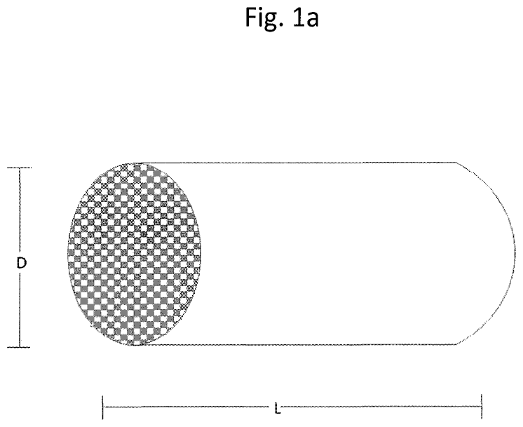

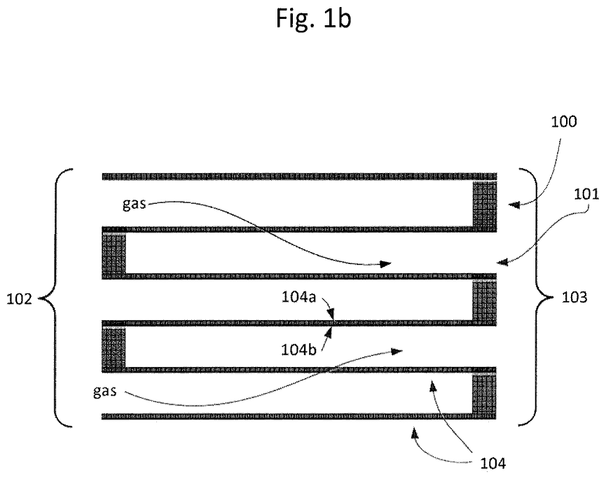

Referring to FIG. 1a, the exemplary wall-flow filter substrate has a cylindrical shape and a cylindrical outer surface having a diameter D and an axial length L. FIG. 1b is a perspective view of an exemplary wall-flow filter. A cross-section view of a monolithic wall-flow filter substrate section is illustrated in FIG. 1b, showing alternating plugged and open passages (cells). Blocked or plugged ends 100 alternate with open passages 101, with each opposing end open and blocked, respectively. The filter has an inlet end 102 and outlet end 103. The arrows crossing porous cell walls 104 represent exhaust gas flow entering the open cell ends, diffusion through the porous cell walls 104 and exiting the open outlet cell ends. Plugged ends 100 prevent gas flow and encourage diffusion through the cell walls. Each cell wall will have an inlet side 104a and outlet side 104b. The passages are enclosed by the cell walls.

The wall-flow filter article substrate may have a volume of, for instance, from about 50 cm³, about 100 cm³, about 200 cm³, about 300 cm³, about 400 cm³, about 500 cm³, about 600 cm³, about 700 cm³, about 800 cm³, about 900 cm³ or about 1000 cm³ to about 1500 cm³, about 2000 cm³, about 2500 cm³, about 3000 cm³, about 3500 cm³, about 4000 cm³, about 4500 cm³ or about 5000 cm³. Wall-flow filter substrates typically have a wall thickness from about 50 microns to about 2000 microns, for example from about 50 microns to about 450 microns or from about 150 microns to about 400 microns.

The walls of the wall-flow filter are porous and generally have a wall porosity of at least about 50% or at least about 60% with an average pore size of at least about 5 microns prior to disposition of the functional coating. For instance, the wall-flow filter article substrate in some embodiments will have a porosity of ≥50%, ≥60%, ≥65% or ≥70%. For instance, the wall-flow filter article substrate will have a wall porosity of from about 50%, about 60%, about 65% or about 70% to about 75%, about 80% or about 85% and an average pore size of from about 5 microns, about 10, about 20, about 30, about 40 or about 50 microns to about 60 microns, about 70, about 80, about 90 or about 100 microns prior to disposition of a catalytic coating. The terms “wall porosity” and “substrate porosity” mean the same thing and are interchangeable. Porosity is the ratio of void volume divided by the total volume of a substrate. Pore size may be determined according to ISO15901-2 (static volumetric) procedure for nitrogen pore size analysis. Nitrogen pore size may be determined on Micromeritics TRISTAR 3000 series instruments. Nitrogen pore size may be determined using BJH (Barrett-Joyner-Halenda) calculations and 33 desorption points. Useful wall-flow filters have high porosity, allowing high loadings of catalyst compositions without excessive backpressure during operation.

### Coating Compositions

Present catalytic coating compositions may be prepared using a binder, for example, a ZrO₂ binder derived from a suitable precursor such as zirconyl acetate or any other suitable zirconium precursor such as zirconyl nitrate. Zirconyl acetate binders provide a coating that remains homogeneous and intact after thermal aging, for example, when the catalyst is exposed to high temperatures of at least about 600° C., for example, about 800° C. and higher water vapor environments of about 5% or more. Other potentially suitable binders include, but are not limited to, alumina and silica. Alumina binders include aluminum oxides, aluminum hydroxides and aluminum oxyhydroxides. Aluminum salts and colloidal forms of alumina many also be used. Silica binders include various forms of SiO₂, including silicates and colloidal silica. Binder compositions may include any combination of zirconia, alumina and silica. Other exemplary binders include boehemite, gamma-alumina, or delta/theta alumina, as well as silica sol. When present, the binder is typically used in an amount of about 1-5 wt. % of the total washcoat loading. Alternatively the binder can be zirconia-based or silica-based, for example zirconium acetate, zirconia sol or silica sol. When present, the alumina binder is typically used in an amount of about 0.05 g/in³ to about 1 g/in³.

The present catalytic coating may comprise one or more coating layers, where at least one layer comprises the present catalyst composition. The present catalytic coating may comprise a single layer or multiple coating layers. The catalytic coating may comprise one or more thin, adherent coating layers disposed on and in adherence to least a portion of a substrate. The entire coating comprises the individual “coating layers”.

In some embodiments, the present catalytic articles may include the use of one or more catalyst layers and combinations of one or more catalyst layers. Catalytic materials may be present on the inlet side of the substrate wall alone, the outlet side alone, both the inlet and outlet sides, or the wall itself may consist all, or in part, of the catalytic material. The catalytic coating may be on the substrate wall surfaces and/or in the pores of the substrate walls, that is “in” and/or “on” the substrate walls. Thus, the phrase “a catalytic coating disposed on the substrate” means on any surface, for example on a wall surface and/or on a pore surface.

The present catalyst compositions may typically be applied in the form of a washcoat, containing support material having catalytically active species thereon. A washcoat is formed by preparing a slurry containing a specified solids content (e.g., about 10 to about 60% by weight) of supports in a liquid vehicle, which is then applied to a substrate and dried and calcined to provide a coating layer. If multiple coating layers are applied, the substrate is dried and calcined after each layer is applied and/or after the number of desired multiple layers are applied. In one or more embodiments, the catalytic material(s) are applied to the substrate as a washcoat. Binders may also be employed as described above.

The above-noted catalyst composition(s) are generally independently mixed with water to form a slurry for purposes of coating a catalyst substrate, such as a honeycomb-type substrate. In addition to the catalyst particles, the slurry may optionally contain a binder (e.g., alumina, silica), water-soluble or water-dispersible stabilizers, promoters, associative thickeners, and/or surfactants (including anionic, cationic, non-ionic or amphoteric surfactants). A typical pH range for the slurry is about 3 to about 6. Addition of acidic or basic species to the slurry can be carried out to adjust the pH accordingly. For example, in some embodiments, the pH of the slurry is adjusted by the addition of ammonium hydroxide or aqueous nitric acid.

The slurry can be milled to enhance mixing of the particles and formation of a homogenous material. The milling can be accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D₉₀ particle size of about 10 to about 40 microns, preferably 10 to about 30 microns, more preferably about 10 to about 15 microns.

The slurry is then coated on the catalyst substrate using any washcoat technique known in the art. In one embodiment, the catalyst substrate is dipped one or more times in the slurry or otherwise coated with the slurry. Thereafter, the coated substrate is dried at an elevated temperature (e.g., 100-150° C.) for a period of time (e.g., 10 min-3 hours) and then calcined by heating, e.g., at 400-600° C., typically for about 10 minutes to about 3 hours. Following drying and calcining, the final washcoat coating layer can be viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

The washcoat(s) can be applied such that different coating layers may be in direct contact with the substrate. Alternatively, one or more “undercoats” may be present, so that at least a portion of a catalytic or sorbent coating layer or coating layers are not in direct contact with the substrate (but rather, are in contact with the undercoat). One or more “overcoats” may also be present, so that at least a portion of the coating layer or layers are not directly exposed to a gaseous stream or atmosphere (but rather, are in contact with the overcoat). The present catalyst composition may be in a bottom layer over a substrate.

Alternatively, the present catalyst composition may be in a top coating layer over a bottom coating layer. The catalyst composition may be present in a top and a bottom layer. Any one layer may extend the entire axial length of the substrate, for instance a bottom layer may extend the entire axial length of the substrate and a top layer may also extend the entire axial length of the substrate over the bottom layer. Each of the top and bottom layers may extend from either the inlet or outlet end.

For example, both bottom and top coating layers may extend from the same substrate end where the top layer partially or completely overlays the bottom layer and where the bottom layer extends a partial or full length of the substrate and where the top layer extends a partial or full length of the substrate. Alternatively, a top layer may overlay a portion of a bottom layer. For example, a bottom layer may extend the entire length of the substrate and the top layer may extend about 10%, about 20%, about 30%, about 40%, about 50%, about 60%, about 70%, about 80% or about 90% of the substrate length, from either the inlet or outlet end.

Alternatively, a bottom layer may extend about 10%, about 15%, about 25%, about 30%, about 40%, about 45%, about 50%, about 55%, about 60%, about 65%, about 70%, about 75%, about 80%, about 85% or about 95% of the substrate length from either the inlet end or outlet end and a top layer may extend about 10%, about 15%, about 25%, about 30%, about 40%, about 45%, about 50%, about 55%, about 60%, about 65%, about 70%, about 75%, about 80%, about 85% or about 95% of the substrate length from either the inlet end of outlet end, wherein at least a portion of the top layer overlays the bottom layer. This “overlay” zone may for example extend from about 5% to about 80% of the substrate length, for example about 5%, about 10%, about 20%, about 30%, about 40%, about 50%, about 60% or about 70% of the substrate length.

Top and/or bottom coating layers may be in direct contact with the substrate. Alternatively, one or more “undercoats” may be present, so that at least a portion of the top and/or the bottom coating layers are not in direct contact with the substrate (but rather with the undercoat). One or more “overcoats” may also be present, so that at least a portion of the top and/or bottom coating layers are not directly exposed to a gaseous stream or atmosphere (but rather are in contact with the overcoat). An undercoat is a layer “under” a coating layer, an overcoat is a layer “over” a coating layer and an interlayer is a layer “between” two coating layers.

The top and bottom coating layers may be in direct contact with each other without any interlayer. Alternatively, different coating layers may not be in direct contact, with a “gap” between the two zones. An interlayer, if present, may prevent the top and bottom layers from being in direct contact. An interlayer may partially prevent the top and bottom layers from being in direct contact and thereby allow for partial direct contact between the top and bottom layers. The interlayer(s), undercoat(s) and overcoat(s) may contain one or more catalysts or may be free of catalysts. The present catalytic coatings may comprise more than one identical layers, for instance more than one layer containing identical catalyst compositions.

Advantageously, the catalytic coating contains a first coating layer comprising the present catalyst composition comprising a PGM component and an alkali or alkali earth metal component; and a second coating layer comprising a second catalyst composition comprising a PGM component on a support and essentially no alkali or alkali earth metal components. The first or second coating layers may be a top or bottom coating layer.

The catalytic coating may advantageously be “zoned,” comprising zoned catalytic layers, that is, where the catalytic coating contains varying compositions across the axial length of the substrate. This may also be described as “laterally zoned”. For example, a layer may extend from the inlet end towards the outlet end extending about 10%, about 20%, about 30%, about 40%, about 50%, about 60%, about 70%, about 80%, or about 90% of the substrate length. Another layer may extend from the outlet end towards the inlet end extending about 10%, about 20%, about 30%, about 40%, about 50%, about 60%, about 70%, about 80%, or about 90% of the substrate length. Different coating layers may be adjacent to each other and not overlay each other. Alternatively, different layers may overlay a portion of each other, providing a third “middle” zone. The middle zone may, for example, extend from about 5% to about 80% of the substrate length, for example about 5%, about 10%, about 20%, about 30%, about 40%, about 50%, about 60% or about 70% of the substrate length.

Different layers may each extend the entire length of the substrate or may each extend a portion of the length of the substrate and may overlay or underlay each other, either partially or entirely. Each of the different layers may extend from either the inlet or outlet end. Different catalytic compositions may reside in each separate coating layer. The present catalytic coatings may comprise more than one identical layer.

Zones of the present disclosure are defined by the relationship of coating layers. With respect to different coating layers, there are a number of possible zoning configurations. For example, there may be an upstream zone and a downstream zone, there may be an upstream zone, a middle zone and a downstream zone, there may four different zones, etc. Where two layers are adjacent and do not overlap, there are upstream and downstream zones. Where two layers overlap to a certain degree, there are upstream, downstream and middle zones. Where for example, a coating layer extends the entire length of the substrate and a different coating layer extends from the outlet end a certain length and overlays a portion of the first coating layer, there are upstream and downstream zones.

For instance, the article may comprise an upstream zone comprising the first coating layer comprising the present catalyst composition comprising a PGM component and an alkali or alkali earth metal component; and a downstream zone comprising the second coating layer comprising a second catalyst composition comprising a PGM component on a support and essentially no alkali or alkali earth metal components.

Alternatively, an upstream zone may comprise the second coating layer and a downstream zone may comprise the first coating layer.

Advantageously, an upstream zone contains essentially no alkali or alkali earth metal components.

In some embodiments, first and second coating layers may be overlaid, either first over second or second over first (i.e. top/bottom), for example where the first coating layer extends from the inlet end towards the outlet end and where the second coating layer extends from the outlet end towards the inlet end. In this case, the catalytic coating will comprise an upstream zone, a middle (overlay) zone and a downstream zone. The first and/or second coating layers may be synonymous with the above top and/or bottom layers described above.

In another embodiment, a first coating layer may extend from the inlet end towards the outlet end and a second coating layer may extend from the outlet end towards the inlet end, where the layers do not overlay each other, for example they may be adjacent.

With respect to the oxidation catalyst composition disclosed herein, the concentration of PGM component in the upstream zone may be less than, greater than or equal to the concentration of PGM component in the downstream zone. Supports in an upstream zone and a downstream zone may be the same or different.

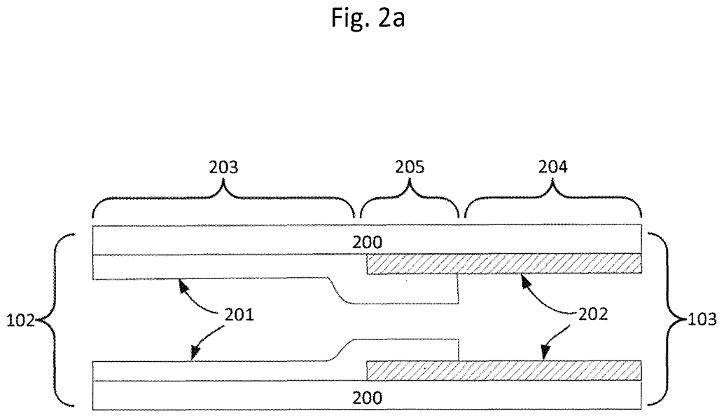

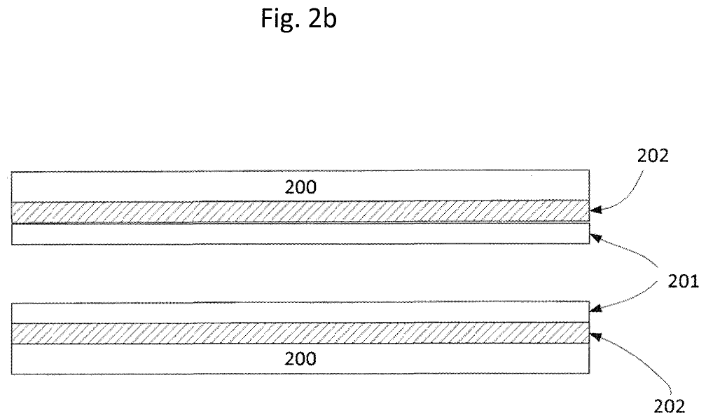

FIG. 2a and FIG. 2b show some possible coating layer configurations with two coating layers. Shown are substrate walls 200 onto which coating layers 201 (top coat) and 202 (bottom coat) are disposed. This is a simplified illustration, and in the case of a porous wall-flow substrate, not shown are pores and coatings in adherence to pore walls and not shown are plugged ends. In FIG. 2a, bottom coating layer 202 extends from the outlet about 50% of the substrate length and top coating layer 201 extends from the inlet greater than 50% of the length and overlays a portion of layer 202, providing an upstream zone 203, a middle overlay zone 205 and a downstream zone 204. In FIG. 2b, coating layers 201 and 202 each extend the entire length of the substrate with top layer 201 overlaying bottom layer 202. The substrate of FIG. 2b does not contain a zoned coating configuration. FIG. 2a and FIG. 2b may be useful to illustrate coating compositions on a wall-through substrate or the flow-through substrate.

The present catalytic coating, as well as any zone or any layer or any section of a coating, is present on the substrate at a loading (concentration) of for instance from about 0.3 g/in² to about 6.0 g/in², or from about 0.4, about 0.5, about 0.6, about 0.7, about 0.8, about 0.9 or about 1.0 g/in² to about 1.5 g/in², about 2.0 g/in³, about 2.5 g/in³, about 3.0 g/in³, about 3.5 g/in³, about 4.0 g/in³, about 4.5 g/in³, about 5.0 g/in³ or about 5.5 g/in³, based on the volume of the substrate. This refers to dry solids weight per volume of substrate, for example per volume of a honeycomb monolith. Concentration is based on a cross-section of a substrate or on an entire substrate. In some embodiments, a top coating layer is present at a lower loading than the bottom coating layer.

A catalytic layer or total coating may comprise any of the refractory metal oxides and in any amount. For example the refractory metal oxides in a catalytic layer may comprise at least about 15, at least about 20, at least about 25, at least about 30 or at least about 35 wt. % alumina where the wt. % is based on the total dry weight of the catalytic layer. A catalytic layer may for example comprise from about 15 to about 95 wt. % alumina or from about 20 to about 85 wt. % alumina. A catalytic layer (or total coating) comprises for example from about 15 wt. %, about 20 wt. %, about 25 wt. %, about 30 wt. % or about 35 wt. % to about 50 wt. %, about 55 wt. %, about 60 wt. % about 65 wt. % or about 70 wt. % alumina based on the weight of the catalytic layer. A refractory metal oxide support may be present for instance in a concentration of from about 0.5 g/in², about 0.8 g/in³ or about 1.0 g/in³ to about 2.0 g/in³, about 3.0 g/in³, about 4.0 g/in³, about 5.0 g/in³ or about 6.0 g/in³, based on the substrate.

The loading of the platinum group metal component of the disclosed oxidation catalyst composition may be in the range of about 2 g/ft³, about 5 g/ft³, about 10 g/ft³ to about 250 g/ft³, for example from about 20 g/ft³, about 30 g/ft³, about 40 g/ft³, about 50 g/ft³ or about 60 g/ft³ to about 100 g/ft³, about 150 g/ft³ or about 200 g/ft³, about 210 g/ft³, about 220 g/ft³, about 230 g/ft³, about 240 g/ft³ or about 250 g/ft³, based on the volume of the substrate. The PGM component is for example present in a catalytic layer from about 0.1 wt. %, about 0.5 wt. %, about 1.0 wt. %, about 1.5 wt. % or about 2.0 wt. % to about 3 wt. %, about 5 wt. %, about 7 wt. %, about 9 wt. %, about 10 wt. %, about 12 wt. % or about 15 wt. %, based on the weight of the layer. A PGM component may be present in a top and bottom catalytic layer also at these levels.

A platinum group metal component in different coating layers may be identical or different. Likewise, the amounts of platinum group metal components in different layers may be identical or different.

Optionally, the present catalytic coating layers may comprise a further catalytically active metal. Non-limiting examples of such catalytically active metals include any one or more of Cu, Fe, Mn, Mg, Co and Ni. Such further catalytically active metals may be present in a catalytic coating from about 3 g/ft³, about 4 g/ft³, about 5 g/ft³, about 6 g/ft³, about 7 g/ft³, about 8 g/ft³, about 9 g/ft³, or about 10 g/ft³, to about 12 g/ft³, about 14 g/ft³, about 16 g/ft³, about 18 g/ft³, about 20 g/ft³, about 22 g/ft³, about 24 g/ft³, about 26 g/ft³, about 28 g/ft³, about 30 g/ft³, about 35 g/ft³, or about 40 g/ft³, based on the volume of the substrate.

Optionally, the present catalytic coating layers may further comprise any one or more of the oxides of lanthanum, barium, praseodymium, neodymium, samarium, strontium, calcium, magnesium, niobium, hafnium, gadolinium, manganese, iron, tin, zinc or copper.

### Exhaust Gas Treatment Systems

The present disclosure generally provides catalyst compositions, catalyst articles and catalyst systems comprising such catalyst articles which exhibit the ability to oxidize HC and CO and NOₓ with reduced formation of N₂O. The present disclosure therefore provides an emission treatment system that incorporates the catalytic articles described herein, such as an emission treatment system generally comprising an engine producing an exhaust gas stream and one or more catalytic articles positioned downstream from the engine in fluid communication with the exhaust gas stream. The engine can be, e.g., a diesel engine which operates at combustion conditions with air in excess of that required for stoichiometric combustion, i.e. lean conditions. In other embodiments, the engine can be an engine associated with a stationary source (e.g., electricity generators or pumping stations). In some embodiments, the emission treatment system further comprises one or more additional catalytic components. The relative placement of the various catalytic components present within the emission treatment system can vary.

In the present exhaust gas treatment systems and methods, the exhaust gas stream is received into the article(s) or treatment system by entering the upstream end and exiting the downstream end. The inlet end of a substrate or article is synonymous with the “upstream” end or “front” end. The outlet end is synonymous with the “downstream” end or “rear” end. The treatment system is, in general, downstream of and in fluid communication with an internal combustion engine.

A system contains more than one article, for instance, a diesel oxidation catalyst (DOC) and one or more articles containing a reductant injector, a selective catalytic reduction catalyst (SCR), a soot filter, an ammonia oxidation catalyst (AMOx) or a lean NOx trap (LNT). An article containing a reductant injector is a reduction article. A reduction system includes a reductant injector and/or a pump and/or a reservoir, etc.

Also disclosed are oxidation systems comprising a first catalytic article comprising a first substrate comprising the first catalytic coating layer comprising the present catalyst composition comprising a PGM component and an alkali or alkali earth metal component and a second catalytic article comprising a second substrate comprising the second catalytic coating layer comprising a second PGM component on a support and essentially no alkali or alkali earth metal components, where the first and second articles are in fluid communication and where for example the second article is downstream of the first article. Alternatively, the first article may be downstream of the second article. The first article may for example contain essentially no alkali or alkali earth metal components.

The present treatment system may further comprise a selective catalytic reduction catalyst and/or a soot filter and/or an ammonia oxidation catalyst. A soot filter may be uncatalyzed or may be catalyzed (CSF). For instance, the present treatment system may comprise, from upstream to downstream—an article containing a DOC, a CSF, an urea injector, a SCR article and an article containing an AMOx. A lean NOx trap (LNT) may also be included.

The present catalyst compositions, articles, systems, and methods are suitable for treatment of exhaust gas streams of internal combustion engines, for example gasoline, light-duty diesel and heavy duty diesel engines. The catalyst compositions are also suitable for treatment of emissions from stationary industrial processes, removal of noxious or toxic substances from indoor air or for catalysis in chemical reaction processes.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of the claimed embodiments. All of the various embodiments, aspects, and options disclosed herein can be combined in all variations. The scope of the compositions, formulations, methods, and processes described herein include all actual or potential combinations of embodiments, aspects, options, examples, and preferences herein. All patents and publications cited herein are incorporated by reference herein for the specific teachings thereof as noted, unless other specific statements of incorporation are specifically provided.

### EXAMPLES

The present invention is more fully illustrated by the following examples, which are set forth to illustrate the present invention and is not to be construed as limiting thereof. Unless otherwise noted, all parts and percentages are by weight, and all weight percentages are expressed on a dry basis, meaning excluding water content, unless otherwise indicated.

Catalyst Article Preparation

### Example 1. Comparative Catalyst Composition

A comparative catalyst composition comprising Pt on H⁺-Beta zeolite was prepared via an incipient wetness technique with a platinum salt.

### Example 2. Inventive Catalyst Composition Comprising Na and Pt

An inventive catalyst composition comprising Na and Pt on Beta zeolite was prepared via an incipient wetness technique with a Pt salt and sodium nitrate. The powders were dried and calcined at 500° C. for 1 hour. Loadings of Pt and Na were 1 wt. %, based on the total composition. Calcined powders were milled to a D₉₀ of less than 15 microns and coated on 300 cpsi, 5 mil wall, 1×3 inch cordierite ceramic honeycomb cores. Washcoat loading was 2.0 g/in³. Each of the compositions (Examples 1 and 2) contained about 34 g/ft³ platinum.

### Catalyst Article Evaluation

### Example 3. Evaluation of Catalyst Compositions for N₂O Production

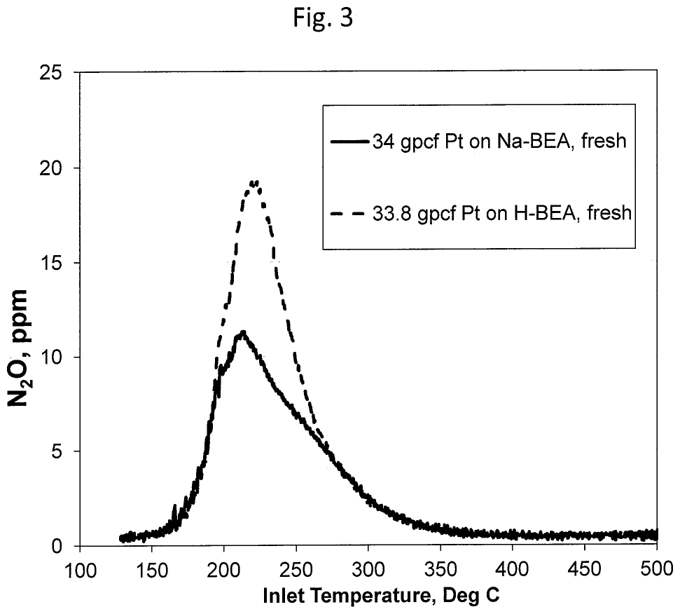

A gas stream inlet was provided, containing concentrations of 500 ppm C₃H₆+C1, 500 ppm CO, 200 ppm NO, 100 ppm toluene+decane+Cl, 5% water, 10% O₂. C1 refers to hydrocarbon concentration per 1 carbon atom. Space velocity=30,000 hr⁻¹. Testing was performed at a temperature ramp of ca. 25° C./min, ramped from 100 to 500° C. and back to 100° C. (two cycles). Outlet concentrations of HC were determined with a flame ionization detector (FID) and outlet concentrations of NO, NO₂, N₂O and CO were measured via FTIR. FIG. 3 graphically illustrates the results of N₂O outlet concentration versus inlet temperature for inventive Example 2 and comparative Example 1. The data demonstrate that Example 2 provided a lower N₂O production.

1. An oxidation catalyst composition comprising:
a first platinum group metal (PGM) component;
a metal component selected from the group consisting of alkali metals and alkali earth metals; and
a support material, wherein the first PGM component and the metal component are supported on the support material.

2. The oxidation catalyst composition of claim 1, wherein the support material comprises a molecular sieve.

3. The oxidation catalyst composition of claim 1, wherein the support material comprises a large pore molecular sieve.

4. The oxidation catalyst composition of claim 1, wherein the support material comprises a molecular sieve selected from the group consisting of framework types AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, RON, RWY, SAF, SAO, SBE, SBS, SBT, SEW, SFE, SFO, SFS, SFV, SOF, SOS, STO, SSF, SSY, USI, UWY, VET, and mixtures or intergrowths thereof.

5. The oxidation catalyst composition of claim 1, wherein the support material comprises a molecular sieve having a silica-to-alumina ratio (SAR) of from about 1 to about 1000.

6. The oxidation catalyst composition of claim 1, wherein the support material comprises a refractory metal oxide.

7. The oxidation catalyst composition of claim 2, wherein the support material further comprises a refractory metal oxide.

8. The oxidation catalyst composition of claim 7, wherein the refractory metal oxide is selected from the group consisting of gamma alumina, silica-alumina, ceria coated on alumina, and titania coated on alumina.

9. The oxidation catalyst composition of claim 7, wherein the refractory metal oxide comprises alumina in an amount from about 15 wt. % to about 95 wt. %, based on the weight of the composition.

10. The oxidation catalyst composition of claim 1, wherein the PGM component is present in an amount from about 0.1 wt. % to about 20 wt. %, based on the weight of the composition.

11. The oxidation catalyst composition of claim 1, wherein the alkali metal or alkali earth metal is present in an amount from about 0.1 wt. % to about 4.0 wt. %, based on the weight of the composition.

12. The oxidation catalyst composition of claim 1, wherein the alkali metal comprises lithium, sodium, potassium, or a combination thereof.

13. The oxidation catalyst composition of claim 1, further comprising one or more catalytically active metals selected from the group consisting of copper, iron, manganese, cobalt, and nickel.

14. A catalytic article comprising a catalyst substrate having an inlet end and an outlet end defining an overall length, and a catalytic coating comprising one or more washcoats disposed thereon, wherein at least one of said washcoats comprises the oxidation catalyst composition of claim 1.

15. The catalytic article of claim 14, wherein the catalytic coating comprises:
a first washcoat comprising the oxidation catalyst composition disposed on at least a portion of the overall length of the catalyst substrate; and
a second washcoat comprising a catalyst composition comprising a second PGM component supported on a second support material disposed on at least a portion of the overall length of the catalyst substrate, wherein the second washcoat contains essentially no alkali metals and alkali earth metals.

16. The catalytic article of claim 15, wherein the second washcoat is disposed directly on the catalyst substrate, and the first washcoat is on at least a portion of the second washcoat.

17. The catalytic article of claim 15, wherein the first washcoat is disposed directly on the catalyst substrate, and the second washcoat is on at least a portion of the first washcoat.

18. The catalytic article of claim 15, having a zoned configuration, wherein the first washcoat is disposed on the catalyst substrate from the inlet end to a length from about 10% to about 70% of the overall length; and the second washcoat is disposed on the catalyst substrate from the outlet end to a length from about 30% to about 90% of the overall length.

19. An exhaust gas treatment system comprising an internal combustion engine and the catalytic article of claim 14, wherein the catalytic article is downstream of and in fluid communication with the internal combustion engine.

20. The exhaust gas treatment system of claim 19, further comprising one or more catalytic articles selected from the group consisting of an urea injector, a selective catalytic reduction (SCR) catalyst, a soot filter, an ammonia oxidation (AMOₓ) catalyst, and a lean-NOₓ trap (LNT).

21. An exhaust gas treatment system comprising:
a first catalytic article comprising a first catalyst substrate having an overall length, the first catalyst substrate having a first washcoat comprising the oxidation catalyst composition of claim 1 disposed on at least a portion of the overall length of the first catalyst substrate; and
a second catalytic article comprising a second catalyst substrate having an overall length, the second catalyst substrate having a second washcoat disposed on at least a portion of the overall length of the second catalyst substrate, the second washcoat comprising a catalyst composition comprising a second PGM component supported on a second support material, wherein the second washcoat contains essentially no alkali metals and alkali earth metals.

22. The exhaust gas treatment system of claim 21, wherein the second catalytic article is downstream of and in fluid communication with the first catalytic article.

23. The exhaust gas treatment system of claim 21, wherein the first catalytic article is downstream of and in fluid communication with the second catalytic article.

24. A method for treating an exhaust gas stream comprising hydrocarbons and/or carbon monoxide and/or NOₓ, the method comprising passing the exhaust gas stream through the catalytic article of claim 15.

25. A method for treating an exhaust gas stream comprising hydrocarbons and/or carbon monoxide and/or NORₓ, the method comprising passing the exhaust gas stream through the exhaust gas treatment system of claim 21.
